(19) United States
(12) Patent Application Publication
(10) Pub. No.: US 2013/0170720 A1
(43) Pub. Date: Jul. 4, 2013

(54) EVALUATION SYSTEM FOR DETERMINATION OF CARDIOVASCULAR FUNCTION PARAMETERS USING ULTRASOUND IMAGES

(71) Applicants: Wei-Chih HU, Chung Li (TW); Chung-Lieh Hung, Taipei (TW); Hung-I Yeh, Taipei (TW)

(72) Inventors: Wei-Chih HU, Chung Li (TW); Chung-Lieh Hung, Taipei (TW); Hung-I Yeh, Taipei (TW)

(73) Assignees: Chung Yuan Christian University, Chung Li (TW); Mackay Memorial Hospital, Taipei City (TW)

(21) Appl. No.: 13/568,982

(22) Filed: Aug. 7, 2012

(30) Foreign Application Priority Data
Jan. 2, 2012 (TW) 101100106

(51) Int. Cl. G06K 9/00

(52) U.S. Cl. 382/131

(57) ABSTRACT

An evaluation system for determination of cardiovascular function parameters using ultrasound images is provided. The evaluation system includes a data reading module, a 2D image generating module, a contour determination module, an active contour module, a geometric center axis computing module, and a function evaluation module. After reading cardiovascular ultrasonographic files with the data reading module, the 2D image generating module displays 2D images. Then, active contours are generated by the contour determination module and the active contour module, so as for the geometric center axis computing module to calculate geometric center axes. Finally, the function evaluation module calculates evaluation parameters according to the geometric center axes. Thus, evaluation parameters can be derived from cardiovascular ultrasound images for clinical diagnosis in the evaluation of cardiovascular functions.

### BACKGROUND OF THE INVENTION

1. Technical Field

The present invention relates to an evaluation system for determination of cardiovascular function parameters using ultrasound images and, more particularly, to such an evaluation system for use in clinical diagnosis.

2. Description of Related Art

Cardiac function parameters such as the ejection fraction and the ventricular volume are typically evaluated by nuclear medicine diagnosis, and this has been the case for quite a long time. Basically, the evaluation process involves injecting a radioactive tracer (e.g., Tc-99m) into a patient's or a test subject's body, allowing the tracer to be distributed evenly in the patient's or the test subject's blood. Then, by detecting the distribution, and variation thereof, of the radioactive tracer in the patient's or the test subject's heart with a nuclear medicine imaging apparatus, the ejection fraction and the ventricular volume can be evaluated. As radioactive tracers are harmful to the human body, it is highly desirable that cardiac function parameters can be directly derived from images obtained by non-invasive photographic techniques that feature non-ionizing radiation, with a view to reducing patients' and test subjects' exposure to radiation.

U.S. Pat. No. 7,603,154 discloses a method for estimating the left ventricular (LV) volume during a cardiac cycle using endocardial contours in three-dimensional (3D) cardiac images taken at end diastole, wherein the contours can be manually specified or semi-automatically derived. Based on the contours and on the pixel intensity of all the images, the LV volume is estimated according to intensity variations within the area enclosed by the contours. The ventricular volume and the ejection fraction can be derived in this way because the intensity variations are related to the change in size of the ventricle.

While U.S. Pat. No. 7,603,154 discloses a method whereby function parameters related to the ventricular volume can be derived from 3D cardiac images, the calculation of other cardiac function parameters (e.g., a ventricular wall displacement parameter) remains unsolved. Nowadays, methods for obtaining cardiovascular images by non-ionizing radiation techniques and deriving cardiac function parameters other than those related to the ventricular volume from the cardiovascular images in real time are still unavailable. Hence, there is a need to develop a method by which cardiovascular function parameters other than those related to the ventricular volume can be evaluated using cardiovascular ultrasound images.

### BRIEF SUMMARY OF THE INVENTION

The present invention discloses an evaluation system for determination of cardiovascular function parameters using ultrasound images, wherein the evaluation system includes a data reading module, a two-dimensional (2D) image generating module, a contour determination module, an active contour module, a geometric center axis computing module, and a function evaluation module. The present invention aims to achieve real-time evaluation of cardiovascular functions by means of ultrasound images.

The present invention provides an evaluation system implemented in a computer hardware system and configured for determination of cardiovascular function parameters using ultrasound images. The evaluation system includes: a data reading module for reading at least one ultrasonographic file, each ultrasonographic file including a plurality of 2D image files that are related to one another and are successively created at a plurality of time points in a time sequence; a 2D image generating module for displaying the 2D image files as a plurality of 2D images; a contour determination module for receiving point selection information generated by a user by selecting points in any said 2D image corresponding to an initial said time point, and for determining an initial contour in each said 2D image corresponding to the initial time point according to the point selection information; an active contour module for reading the initial contours and determining the active contour in each 2D image; a geometric center axis computing module for reading the active contours and computing the geometric center axis corresponding to each time point; and a function evaluation module for successively computing the difference between the active contours corresponding to each time point in the time sequence and the corresponding geometric center axis, so as to generate an evaluation parameter.

Implementation of the present invention at least achieves the following objectives:

1. Cardiovascular ultrasound images can be shown in real time in three dimensions to enable calculation of cardiovascular evaluation parameters.

2. Abnormal myocardial wall activity as well as the volume and distribution of the pericardium can be detected in real time both qualitatively and quantitatively in 360 degrees.

3. Analysis across adjacent and yet different cardiac structures can be made.

Hereinafter, the detailed features and advantages of the present invention are described in detail by way of the preferred embodiments of the present invention so as to enable persons skilled in the art to gain insight into the technical disclosure of the present invention, implement the present invention accordingly, and readily understand the objectives and advantages of the present invention by making reference to the disclosure of the specification, the claims, and the drawings of the present invention.

### BRIEF DESCRIPTION OF THE SEVERAL VIEWS OF THE DRAWINGS

FIG. 1 is a block diagram showing the first aspect of an evaluation system according to an embodiment of the present invention;

FIG. 2 is an image sequence diagram showing the data structure according to an embodiment of the present invention;

FIG. 3A schematically shows the reference points for an epicardial contour according to an embodiment of the present invention;

FIG. 3B schematically shows the reference points for the positions of the apex and the base of the heart according to an embodiment of the present invention;

FIG. 3C schematically shows an initial contour according to an embodiment of the present invention;

FIG. 4A schematically shows an active contour module interface according to an embodiment of the present invention;

FIG. 4B is an image sequence diagram showing active contours according to an embodiment of the present invention;

FIG. 5 schematically shows a curvature method according to an embodiment of the present invention;

FIG. 6 schematically shows a volume evaluation parameter function according to an embodiment of the present invention;

FIG. 7 shows a percent wall motion-time curve according to an embodiment of the present invention;

FIG. 8 shows a percent wall thickening-time curve according to an embodiment of the present invention;

FIG. 9 is a block diagram showing the second aspect of the evaluation system according to the embodiment of FIG. 1;

FIG. 10A schematically shows a real-time 3D viewing module interface according to an embodiment of the present invention;

FIG. 10B shows an original heart model according to an embodiment of the present invention; and

FIG. 10C shows a left ventricle module according to an embodiment of the present invention.

### DETAILED DESCRIPTION OF THE INVENTION

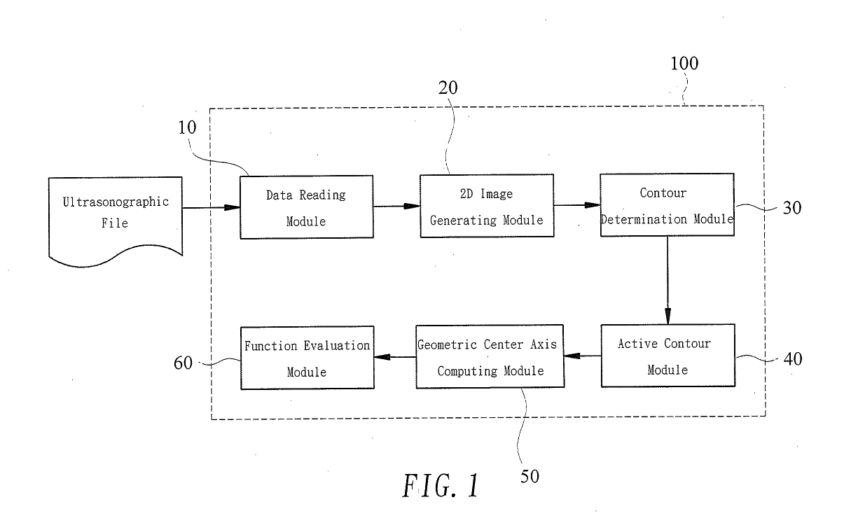

In the embodiment shown in FIG. 1, an evaluation system 100 for determination of cardiovascular function parameters using ultrasound images is implemented in a computer hardware system that at least includes an input/output unit, a memory unit, a logic operation unit, and a control unit. The evaluation system 100 itself includes a data reading module 10, a two-dimensional (2D) image generating module 20, a contour determination module 30, an active contour module 40, a geometric center axis computing module 50, and a function evaluation module 60.

The data reading module 10 is configured for reading at least one ultrasonographic file created by scanning a clinical patient's or a test subject's cardiovascular structures with an ultrasonographic apparatus. Each ultrasonographic file includes a plurality of related 2D image files of different cross-sections, taken from top down, of the cardiovascular structures. More particularly, each cross-section has a series of 2D image files created successively at a plurality of time points (or time frames) in a time sequence.

Each ultrasonographic file can be a Digital Imaging and Communications in Medicine (DICOM) file recorded in the DICOM file format, which essentially includes a header and a data set. When reading such an ultrasonographic file, the data reading module 10 identifies the information in the header, i.e., the patient's basic data and the attributes of the imaging module (e.g., the image capturing speed and the width and height of each image). The information is identified for subsequent processing and use.

The 2D image generating module 20 is configured for constructing information of the data set using the 2D image files read by the data reading module 10 and the imaging module attributes read from the header, so that the 2D image files can be displayed as a plurality of 2D images. However, the displaying of the 2D images may be inconsistent for the following reasons. First of all, as the length of the aforesaid time sequence varies with people's heart rates, the number of time points (or frames) in the time sequence corresponding to a certain heart rate will be different from that corresponding to another. Moreover, the fact that each person's cardiovascular structures vary in size leads to different numbers of cross-sections. In consideration of this, the image sequence in the present embodiment is established according to the queuing order in the data structure, as explained below. To begin with, the head pointer is pointed to the first 2D image, and the tail pointer to the last 2D image. Then, a transient pointer is used to find the 2D image of each cross-section. By doing so, the 2D image generating module 20 can generate 2D images without limitations in the number of cross-sections or in the length of the time sequence.

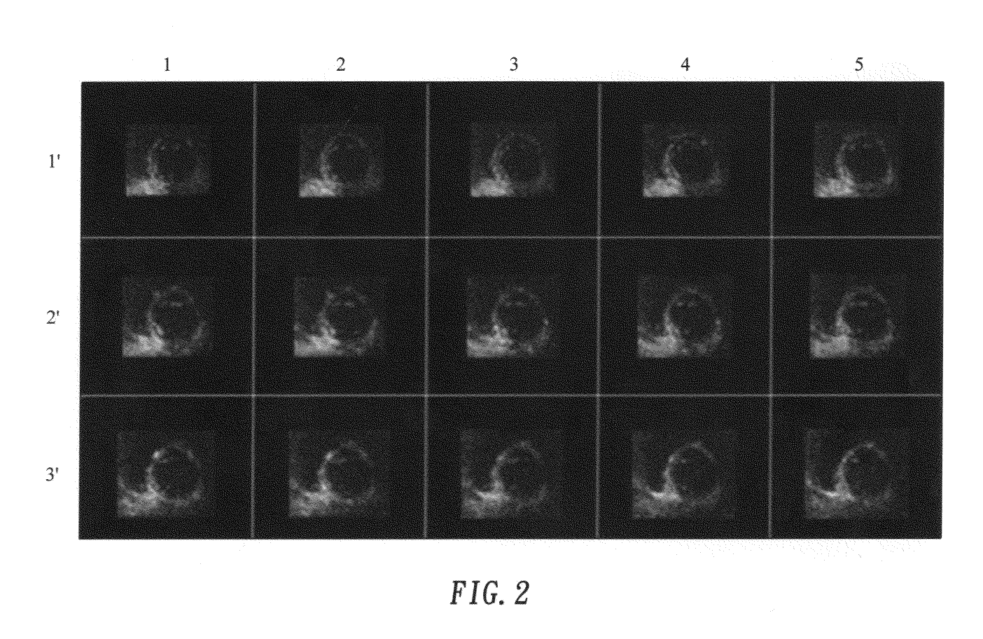

Afterward, referring to FIG. 2, the 2D image generating module 20 displays on a computer screen the 2D images corresponding to all the time points (or frames) and all the cross-sections, in a way similar to a video wall. For instance, the 2D image generating module 20 displays the cross-sections 1˜n corresponding to the frame 1′, the cross-sections 1˜n corresponding to the frame 2′, and so on. By means of a cursor and a scroll wheel, a user not only can easily view the images corresponding to all the frames in a time sequence, but also can choose between the processed images and the original (i.e., unprocessed) images.

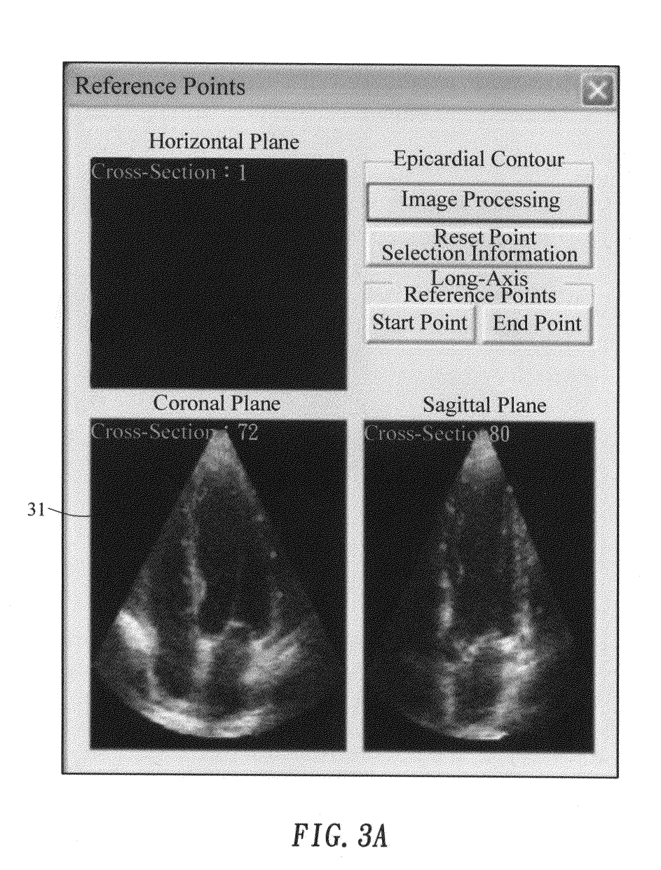

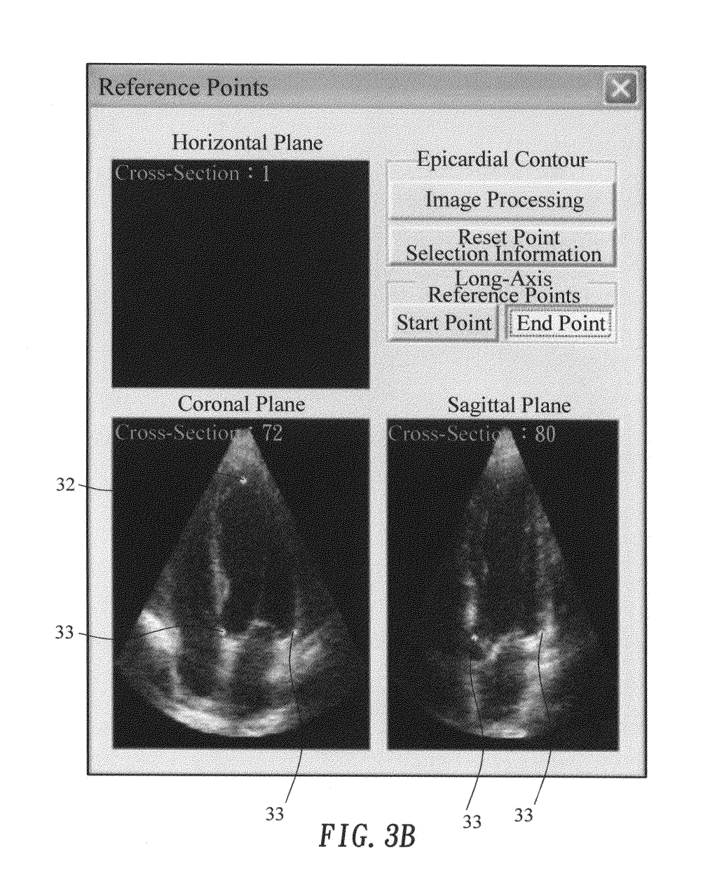

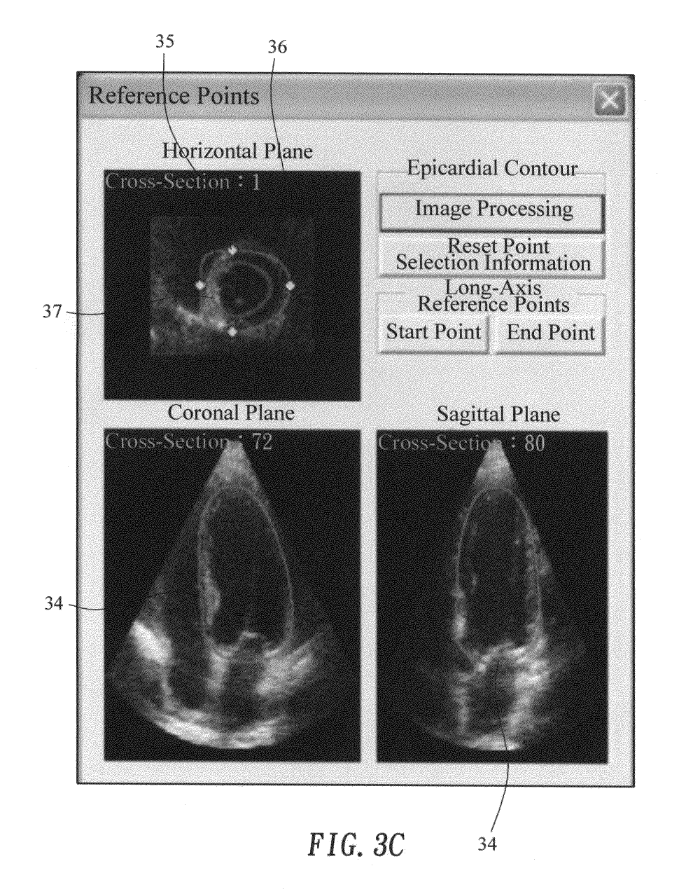

Referring to FIG. 3A, the contour determination module 30 is configured for receiving point selection information generated by a user by selecting points in any of the 2D images on the screen, thus saving the time otherwise required for manual contouring. The point selection information can be a plurality of reference points. Based on the general information provided by the point selection information, the contour determination module 30 performs computation and thereby determines the initial contour in each of the 2D images corresponding to the initial time point according to the point selection information. The initial contour may include an initial endocardial contour and an initial epicardial contour. It should be noted that the point selection information can only be generated from those 2D images that correspond to the initial time point (or frame). Hence, the initial contours are determined only for those 2D images that correspond to the initial time point (or frame).

For example, the contour determination module 30 receives a plurality of epicardial contour reference points 31 which are manually selected by the user from the 2D images in the coronal plane and in the sagittal plane. These epicardial contour reference points 31 are selected at intervals along the epicardial contours in the 2D images according to the user's judgment and experience and will be used to generate closed curves that delineate the epicardial contours.

Then, referring to FIG. 3B, the heart apex position reference point 32, which serves as the starting cross-section in the processing process, is set using the Start Point button under Long-Axis Reference Points, and the End Point button is used to set two heart base position reference points 33 in each of the coronal-plane and sagittal-plane 2D images, thereby defining the terminal cross-section in the processing process. Since the coronal plane and the sagittal plane are perpendicular to each other, the four heart base position reference points 33 jointly define the terminal cross-section. If the point selection information needs resetting, the Reset Point Selection Information button can be used to start re-selection of the points.

Referring to FIG. 3C, once the Image Processing button is pressed, the contour determination module 30 uses a B-spline interpolation function to interpolate the manually selected epicardial contour reference points 31 and thereby generates closed curves 34. The more accurate the epicardial contour reference points 31 are, the more the closed curves 34 will conform to the epicardial contours in the 2D images. By projecting the two closed curves 34, which are generated from the point selection information and lie in the coronal plane and the sagittal plane respectively, to each position-related cardiac 2D image in the horizontal plane, four projected reference points 35 are obtained. Then, an initial contour is determined as follows. An initial epicardial contour 36 is determined by applying a cubic spline function to the projected reference points 35, and an initial endocardial contour 37 is determined by applying a B-spline interpolation function to the projected reference points 35.

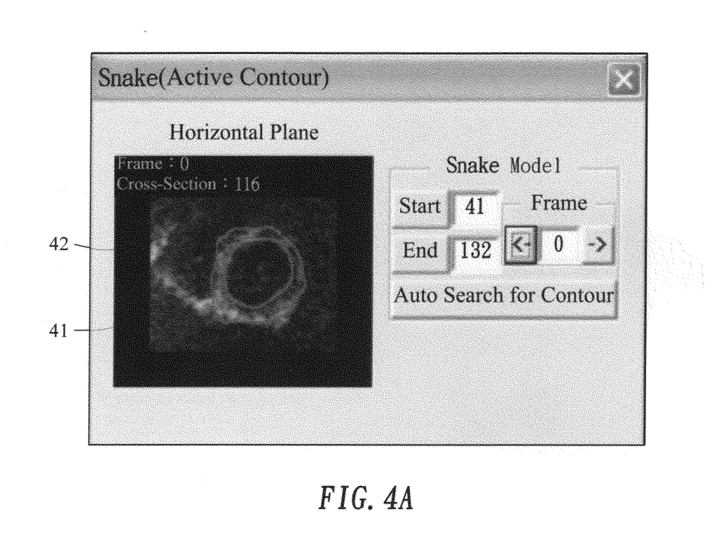

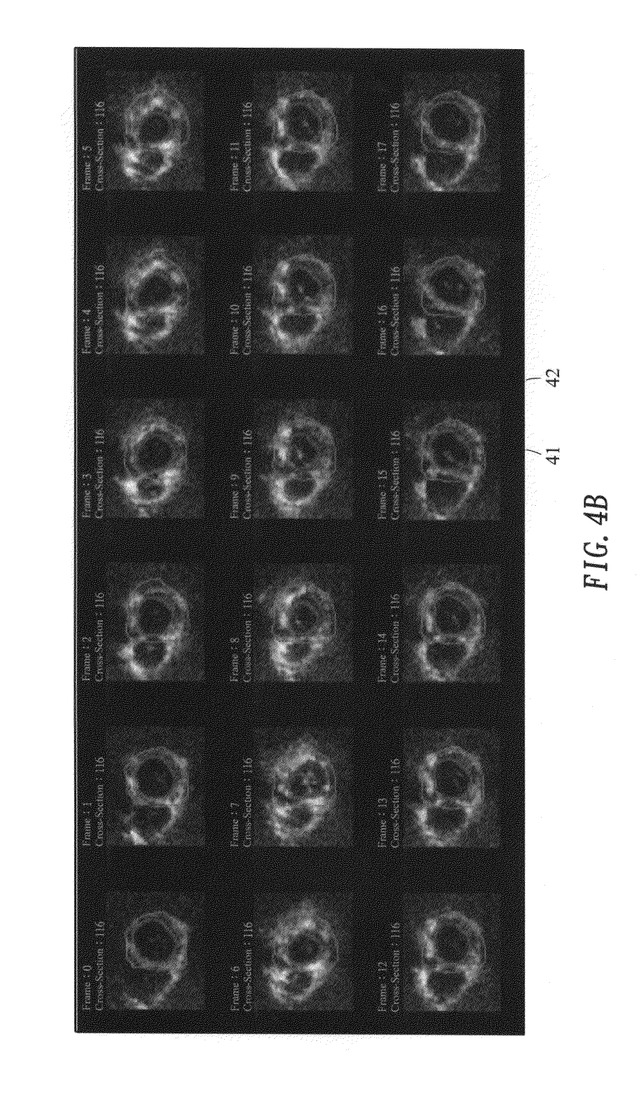

The function of the active contour module 40 is described below with reference to FIGS. 4A and 4B. To begin with, the active contour module 40 reads the initial contours generated by the contour determination module 30 for all the cross-sections corresponding to the initial time point (or frame). Then, by pressing the Auto Search for Contour button, the active contour module 40 is triggered to compute with the Snake model so that the initial contour corresponding to the 2D image on display approaches the real contour in the image. The resultant new contour is used as the starting contour for the following frame, and the computation can be repeated until an active contour is created for each 2D image of the same cross-section. Thus, the active contour in each cross-section at each user-selected frame is obtained. Each active contour may include an active endocardial contour 41 and an active epicardial contour 42, wherein the active endocardial contour 41 is created based on the corresponding initial endocardial contour 37, and the active epicardial contour 42 is created based on the corresponding initial epicardial contour 36. When the images with the active contours are displayed in a manner similar to a video wall, as shown in FIG. 4B, variations of the endocardial contours 41 and of the epicardial contours 42 from diastole to systole can be clearly observed.

The geometric center axis computing module 50 is configured for computing the geometric center axis of the heart, which features an irregular shape and continuous contraction and relaxation. More particularly, the geometric center axis computing module 50 reads the active contours generated by the active contour module 40 (which active contours include the active contour in each cross-section at each time frame), computes the center of each active contour, and generates a geometric center axis by connecting the computed centers of the active contours in all the cross-sections at the same time point (or frame).

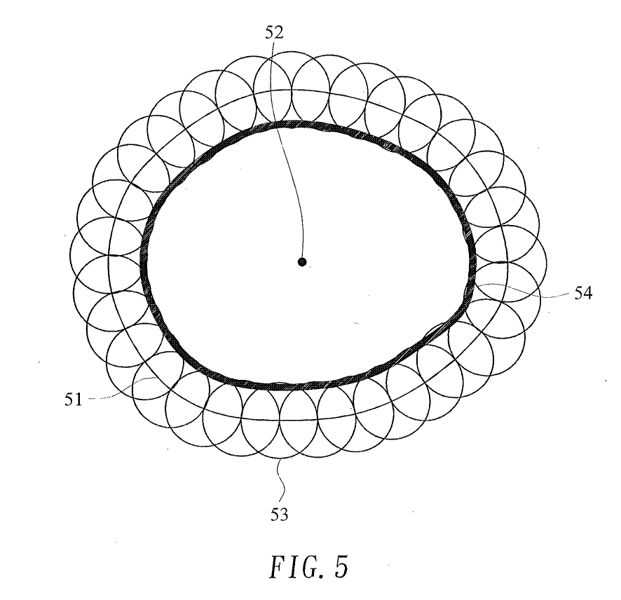

Referring to FIG. 5, the center 52 of the active contour 51 is determined by a curvature method as follows. To start with, the center of a small circle 53 is moved along the active contour 51 such that each two adjacent traces of the circle 53 intersect each other both inside and outside the active contour 51 and thereby define an inner intersection point and an outer intersection point respectively. The inner intersection points jointly form a new closed curve 54. By moving the center of another small circle along the new closed curve 54, a smaller closed curved is formed. The foregoing steps are repeated until the center 52 is obtained in a converging manner.

Thus, each time point (or frame) in the time sequence has a geometric center axis, and the plural geometric center axes in the time sequence change and move with the relaxing and contracting cycle of the heart. These geometric center axes are collectively referred to as the mechanical center axis of the heart. It has been observed that the mechanical center axis of the heart is relatively close to the aorta during systole and to the mitral valve during diastole. As the ventricular wall moves simultaneously with the mechanical center axis of the heart, the actual contraction and relaxation conditions of the heart cannot be accurately evaluated without knowing the variation in the distance between the ventricular wall and the geometric center axis of the heart.

The function evaluation module 60 successively computes the difference between each active contour and the corresponding geometric center axis (i.e., the distance between each active contour and its center) at each time point in the time sequence and generates a cardiac function evaluation parameter based on the differences thus obtained, among other information. The evaluation parameter can be a volume parameter, a displacement parameter, a deformation parameter, or a speed parameter.

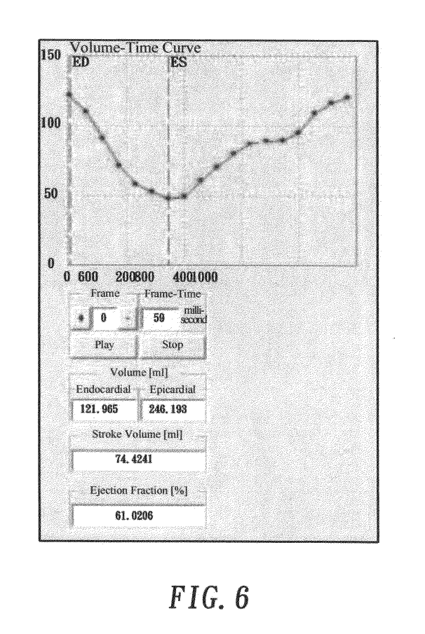

Referring to FIG. 6, the volume parameter can be an end-diastolic volume (EDV), an end-systolic volume (ESV), a stroke volume (SV), or an ejection fraction (EF). To compute the volume parameter, the number of pixels in the area within the left ventricular contour in each cross-section is computed, and the numbers of pixels thus obtained are added up to produce the total number of volumetric pixels (i.e., voxels). Then, the total number of voxels is multiplied by a scaling factor, which is the actual size corresponding to each voxel, and a volume is obtained. After the volumes corresponding to an entire cycle of the left ventricle from diastole to systole are computed, a volume-time curve (VTC) is plotted. The lowest point (ES) of the volume-time curve represents the end-systolic volume, the highest point (ED) represents the end-diastolic volume, and the difference between the end-diastolic volume and the end-systolic volume is the stroke volume. The ejection fraction is the percentage obtained by dividing the stroke volume by the end-diastolic volume.

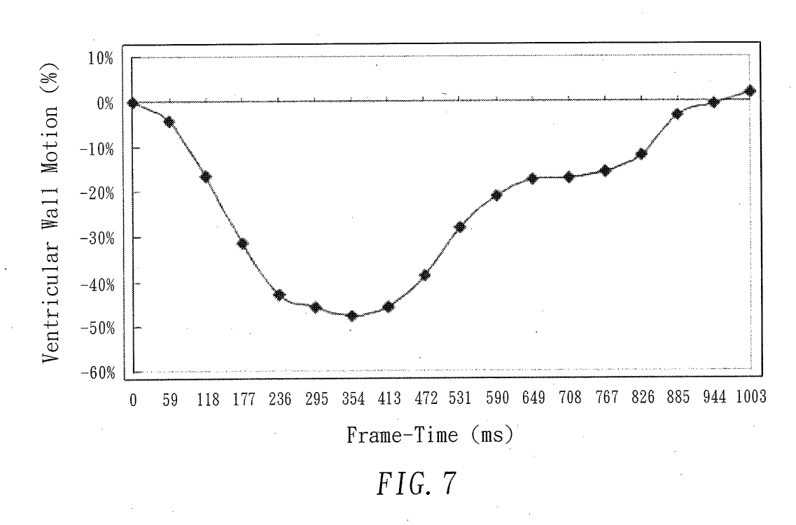

Referring to FIG. 7, the displacement parameter can be a ventricular wall motion parameter. As the heart pumps blood out of the ventricles by contraction of the ventricular wall, cardiac functions can be better understood by evaluating the contracting ability of each segment of the ventricular wall or the contracting ability of the ventricular wall as a whole. To compute the ventricular motion parameter, the difference between the endocardial contour in each cross-section of each segment of the ventricular wall (or of the entire ventricular wall) and the intersection point of the cross-sectional plane of the endocardial contour and the corresponding geometric center axis during a left ventricular wall moving period is computed and averaged, and the result is denoted by R. Also, the difference between the endocardial contour in each cross-section of each segment of the ventricular wall (or of the entire ventricular wall) and the intersection point of the cross-sectional plane of the endocardial contour and the corresponding geometric center axis at end diastole is computed and averaged, and the result is denoted by R_{ed}. The percent wall motion (% WM) is then calculated as (R−R_{ed})/R_{ed}×100%. The ventricular wall can be divided in to six segments, namely a front segment, the anterior ventricular septum, the ventricular septum, a lower segment, a rear segment, and a lateral segment.

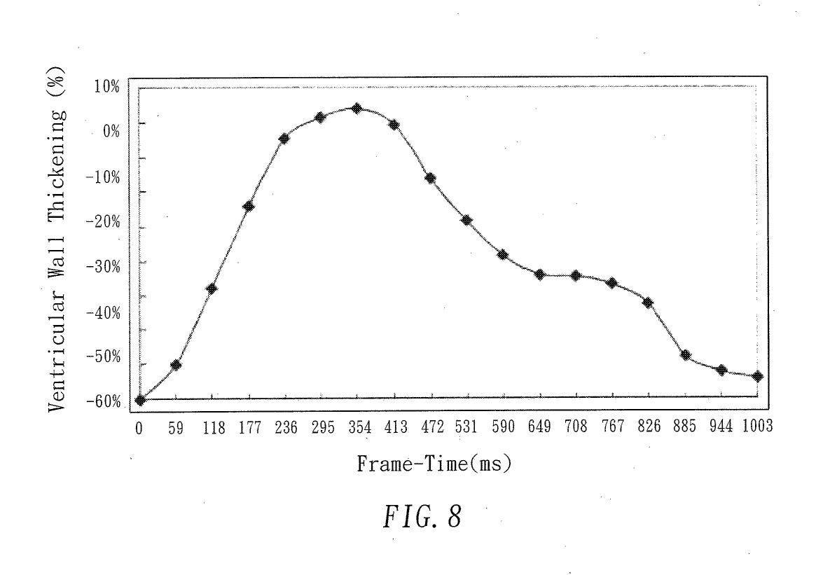

Referring to FIG. 8, the deformation parameter can be a ventricular wall thickness parameter. As the contracting ability of the ventricular wall is related to the extent of myocardial contraction and relaxation, an understanding of how the ventricular wall thickness varies with cardiac muscle contraction and relaxation is helpful in the evaluation of cardiac functions. To compute the ventricular wall thickness parameter, the difference between each endocardial contour and the corresponding epicardial contour of each segment of the ventricular wall (or of the entire ventricular wall) during a left ventricular wall moving period is computed and averaged, and the result is denoted by T. In addition, the difference between each endocardial contour and the corresponding epicardial contour of each segment of the ventricular wall (or of the entire ventricular wall) at end diastole is computed and averaged, and the result is denoted by T_{ed}. The percent wall thickening (% WT) is then calculated as (T−T_{ed})/T_{ed}×100%. The ventricular wall can be divided in to six segments, namely a front segment, the anterior ventricular septum, the ventricular septum, a lower segment, a rear segment, and a lateral segment.

The speed parameter can be a blood flow speed parameter for evaluating vascular functions. To compute the blood flow speed, a vascular volume is calculated by the foregoing method and then divided by the flow-out time.

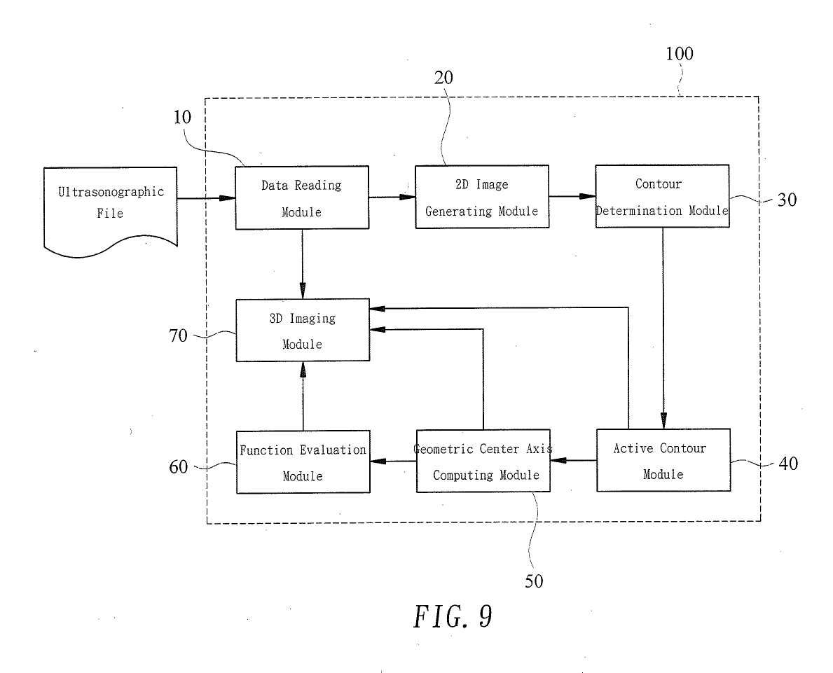

Referring to FIG. 9, the evaluation system in this embodiment further includes a three-dimensional (3D) imaging module 70. The 3D imaging module 70 is configured for reading in real time the aforesaid 2D image files and the active contours 51 generated by the active contour module 40, computing with the files and the contours thus read, and then displaying a 3D image and an image showing the positions of the active contours 51. Using an advanced 3D image function of OpenGL API, the 3D imaging module 70 can enlarge, reduce, and rotate the 3D image and create such special effects as shedding light on and adding textures to the object in the 3D image.

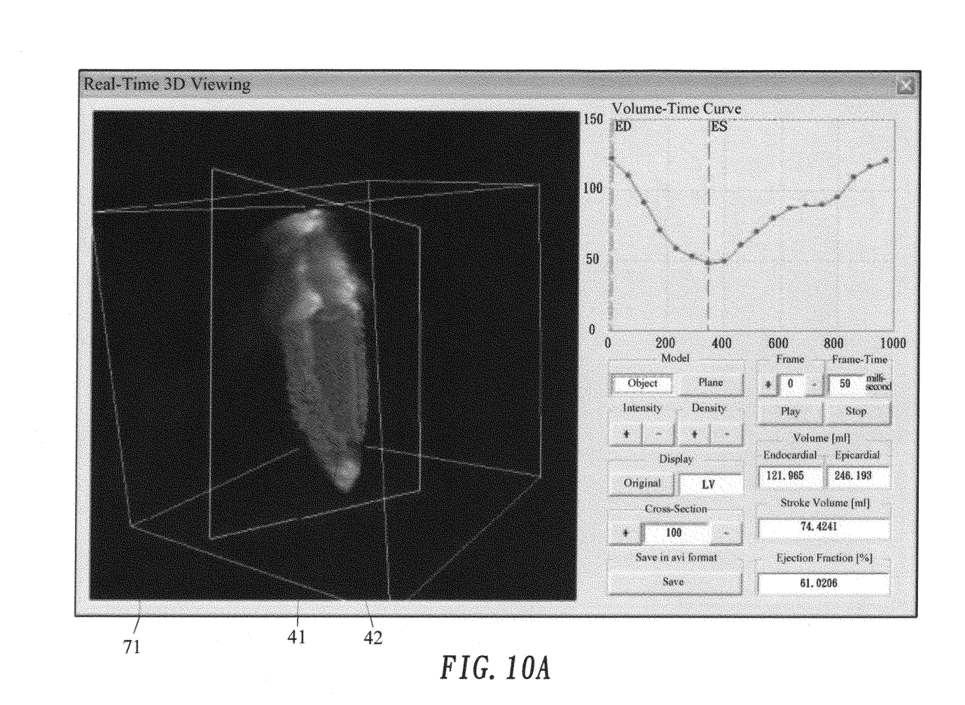

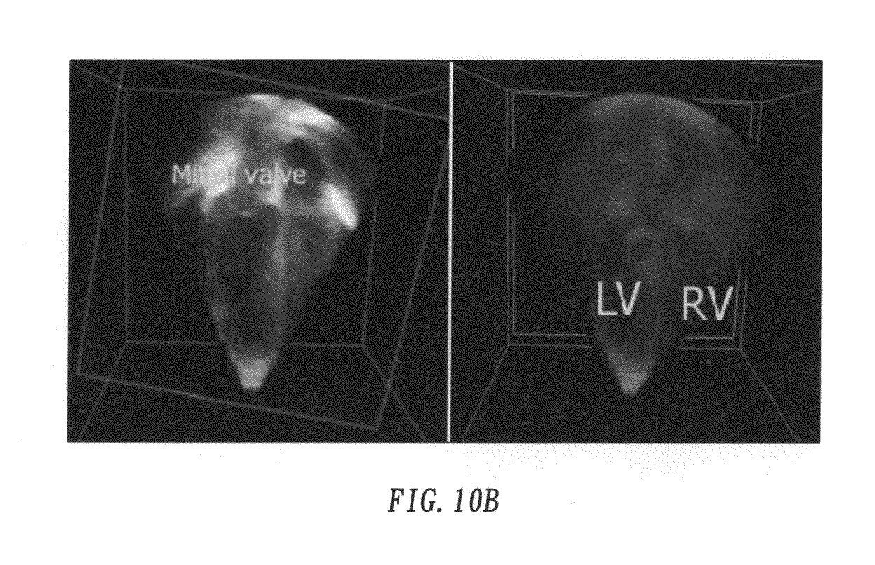

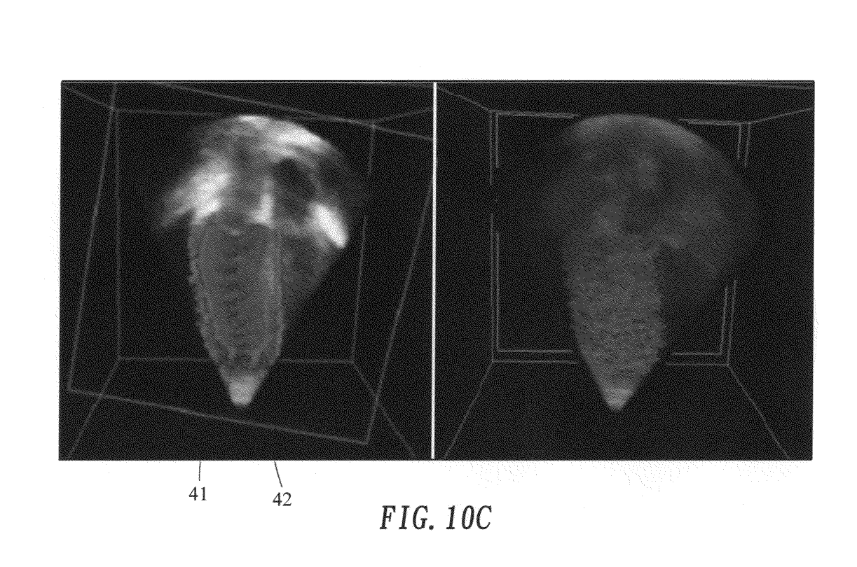

As shown in FIGS. 10A to 10C, when the Object button is selected, the viewing angle and viewing distance of the object in the display area 71 can be controlled by a dragging operation in conjunction with the left/right keys of a mouse. When the Plane button is selected, the position and angle of a cross-section in the display area 71 can be adjusted using the left/right keys of the mouse. Moreover, the 3D imaging module 70 allows selection of the range or portion to be displayed. By selecting the Original button, the original 3D heart model is displayed in its entirety; by selecting the LV button, the left ventricular endocardial contours 41 and the left ventricular epicardial contours 42 (highlighted by their respective active contours in red and green respectively) are displayed in addition to the original 3D heart model. Thus, the structural model and position of the entire left ventricle can be seen.

The features of the present invention are disclosed above by the preferred embodiments to allow persons skilled in the art to gain insight into the contents of the present invention and implement the present invention accordingly. The preferred embodiments of the present invention should not be interpreted as restrictive of the scope of the present invention. Hence, all equivalent modifications or amendments made to the aforesaid embodiments should fall within the scope of the appended claims.

1. An evaluation system for determination of cardiovascular function parameters using ultrasound images, to be implemented in a computer hardware system, the evaluation system comprising:
a data reading module for reading at least an ultrasonographic file, each said ultrasonographic file comprising a plurality of two-dimensional (2D) image files which are related to one another and are successively created at a plurality of time points in a time sequence;
a 2D image generating module for displaying the 2D image files as a plurality of 2D images;
a contour determination module for receiving point selection information generated by a user by selecting points in any said 2D image corresponding to an initial said time point, and for determining an initial contour in each said 2D image corresponding to the initial time point according to the point selection information;
an active contour module for reading the initial contours and determining an active contour in each said 2D image;
a geometric center axis computing module for reading the active contours and computing a geometric center axis corresponding to each said time point; and
a function evaluation module for successively computing a difference between the active contours corresponding to each said time point in the time sequence and a corresponding said geometric center axis, and for generating an evaluation parameter accordingly.

2. The evaluation system of claim 1, wherein each said ultrasonographic file is a Digital Imaging and Communications in Medicine (DICOM) file.

3. The evaluation system of claim 1, wherein each said initial contour comprises an initial endocardial contour and an initial epicardial contour.

4. The evaluation system of claim 1, wherein each said active contour comprises an active endocardial contour and an active epicardial contour.

5. The evaluation system of claim 1, wherein the geometric center axes are determined by a curvature method.

6. The evaluation system of claim 1, wherein the geometric center axes are a mechanical center axis of a heart.

7. The evaluation system of claim 1, further comprising a three-dimensional (3D) imaging module for reading and computing with the 2D image files and the active contours and displaying a 3D image and an image showing positions of the active contours.

8. The evaluation system of claim 1, wherein the evaluation parameter is one of a volume parameter, a displacement parameter, a deformation parameter, and a speed parameter.

9. The evaluation system of claim 8, wherein the volume parameter is one of an end-diastolic volume, an end-systolic volume, a stroke volume, and an ejection fraction.

10. The evaluation system of claim 8, wherein the displacement parameter is a ventricular wall motion parameter.

11. The evaluation system of claim 8, wherein the deformation parameter is a ventricular wall thickness parameter.
